(19) United States
(12) Patent Application Publication
(10) Pub. No.: US 2017/0271988 A1
(43) Pub. Date: Sep. 21, 2017

(54) APPARATUS AND METHOD FOR IMPROVING STANDBY EFFICIENCY OF HANDHELD DEVICE

(71) Applicants: Le Holdings (Beijing) Co., Ltd., Beijing (CN); Le Shi Zhi Xin Electronic Technology (Tianjin) Limited, Tianjin (CN)

(72) Inventor: Yonggui ZHAO, Tianjin (CN)

(21) Appl. No.: 15/250,570

(22) Filed: Aug. 29, 2016

Related U.S. Application Data
(63) Continuation of application No. PCT/CN2016/088467, filed on Jul. 4, 2016.

(30) Foreign Application Priority Data
Mar. 17, 2016 (CN) 201610152285.X

(51) Int. Cl. H02M 3/158; H02M 1/32

(52) U.S. Cl. CPC H02M 3/158; H02M 1/32

(57) ABSTRACT

An apparatus and method for improving standby efficiency of a handheld device is disclosed. The apparatus includes: a power supply, a phase inverter, a field-effect transistor, and a direct/direct (DC/DC) converter and a low-voltage difference voltage stabilizer that are connected in parallel; wherein the power supply provides an input voltage for the DC/DC converter and the low-voltage difference voltage stabilizer, an input port of the phase inverter is connected to an enable port of the low-voltage difference voltage stabilizer, the input port of the phase inverter is connected to an enable port of the DC/DC converter, a gate of the field-effect transistor is connected to an output port of the phase inverter, a drain of the field-effect transistor is connected to an output port of the DC/DC converter, and a source of the field-effect transistor is connected to an output port of the low-voltage difference voltage stabilizer. The apparatus and method for improving standby efficiency of a handheld device according to embodiments of the present disclosure are capable of improving the efficiency of the handheld device in a standby state.

### CROSS-REFERENCE TO RELATED APPLICATIONS

This application is a continuation of International Application No. PCT/CN2016/088467 filed on Mar. 17, 2016, which is based upon and claims priority to Chinese Patent Application No. 201610152285.X, filed before Chinese Patent Office on Mar. 17, 2016 and entitled “APPARATUS AND METHOD FOR IMPROVING STANDBY EFFICIENCY OF HANDHELD DEVICE”, the entire contents of which are incorporated herein by reference.

### TECHNICAL FIELD

The present disclosure relates to the technical field of mobile terminal devices, and more particularly, to an apparatus and method for improving standby efficiency of a handheld device.

### BACKGROUND

In recent years, with the continuous development of mobile terminals, the mobile terminals are well populated in people's daily life, and handheld devices having smaller and smaller size and powerful functions are welcomed by users. Extensive disclosure of the handheld devices shortens the distance among people in terms of time and space. As such, people are imposing higher and higher requirements on the future handheld devices. it is a hot subject to be concerned and studied by communication product manufacturers as whether the future communication products provide more convenient and more effective functions and services.

Using a mobile phone as an example, as well known, the hardware system of the mobile phone is formed of a baseband module and a radio frequency module. The baseband module is mainly responsible for implementing such functions as analog and baseband signal processing, protocol stacks, operating system, apps running, and power supply management, charging, backlight, audio and peripheral devices management and the like. The radio frequency module is mainly responsible for implementing such functions as uplink/downlink frequency conversion of analog baseband signal, filtering, low noise amplification, power amplification, transceiving switching and the like. Using a GSM as an example, the mobile phone generally has the following working modes: 1. a communication service mode in which the mobile phone is in a call or data service communication state; wherein in this mode, the baseband module and the radio frequency module of the mobile phone is in a full working mode, and the mobile phone works in a corresponding maximum power consumption state according to the network and channel quality, an average power consumption is about 300 mA, and an instant power consumption reach 1 A or above; 2. a standby mode in which the mobile phone does not perform any user instruction and operation and stays in a standby state; wherein in this mode, the transmitter of the radio frequency module is disabled, and the receiver, system primary clock and the baseband module (in this case, the baseband module intermittently works in a minimum system power saving working mode) are in an intermittent working mode to intermittently receive and processing cell paging messages whereas the system real-time clock is in a continuous working state to maintain system timing, and in this case the consumed current of the mobile phone is generally less than 1 mA.

Referring to FIG. 1, in the related art, generally a handheld device is power-supplied by a direct/direct (DC/DC) converter arranged in the handheld device. When the handheld device is in a communication service mode, since the DC/DC converter outputs a great current, the working efficiency of the DC/DC converter generally reaches over 90%. However, when the handheld device is in a standby state, the DC/DC converter outputs a small current, and in this case the corresponding working efficiency is quickly attenuated. In this way, the power supply manner for the handheld device in the related art may cause a relatively low standby efficiency, and thus the standby duration of the handheld device is affected.

### SUMMARY

The present disclosure provides an apparatus and method for improving standby efficiency of a handheld device, to improve the efficiency of the handheld device in a standby state.

Embodiments of the present disclosure provide an apparatus for improving standby efficiency of a handheld device. The apparatus includes: a power supply, a phase inverter, a field-effect transistor, and a direct/direct (DC/DC) converter and a low-voltage difference voltage stabilizer that are connected in parallel; wherein the power supply provides an input voltage for the DC/DC converter and the low-voltage difference voltage stabilizer, an input port of the phase inverter is connected to an enable port of the low-voltage difference voltage stabilizer, the input port of the phase inverter is connected to an enable port of the DC/DC converter, a gate of the field-effect transistor is connected to an output port of the phase inverter, a drain of the field-effect transistor is connected to an output port of the DC/DC converter, and a source of the field-effect transistor is connected to an output port of the low-voltage difference voltage stabilizer.

Embodiments of the present disclosure provide a method for improving standby efficiency of a handheld device, applied to a terminal. The method includes: judging a state of the handheld device at a current time; and when the handheld device is in an activated state, supplying power for the handheld device by using an output voltage of a direct/direct (DC/DC) converter; or when the handheld device is in a standby state, supplying power for the handheld device by using an output voltage of a low-voltage difference voltage stabilizer.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram illustrating working efficiency of a handheld device in the related art;

FIG. 2 is a schematic structural diagram of an apparatus for improving standby efficiency of a handheld device according to some embodiments of the present disclosure;

FIG. 3 is a schematic diagram illustrating working efficiency of a handheld device according to some embodiments of the present disclosure;

FIG. 4 is a schematic structural diagram illustrating a low-voltage difference voltage stabilizer according to some embodiments of the present disclosure;

FIG. 5 is a schematic structural diagram illustrating a low-voltage difference voltage stabilizer according to some embodiments of the present disclosure; and

FIG. 6 is a schematic flowchart illustrating a method for improving standby efficiency of a handheld device according to some embodiments of the present disclosure.

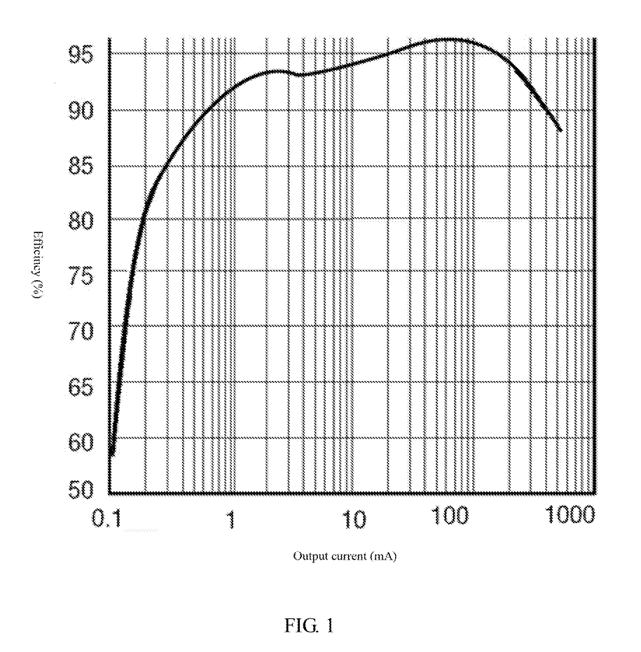

### DETAILED DESCRIPTION

To make the objectives, technical solutions and advantages of the present disclosure clearer, the technical solutions in the embodiments of the present disclosure are described clearly and completely with reference to the accompanying drawings in the embodiments of the present disclosure. Apparently, the described embodiments are merely some of rather than all of the embodiments of the present disclosure. Based on the embodiments of the present disclosure, all other embodiments derived by persons of ordinary skill in the art without any creative efforts shall fall within the protection scope of the present disclosure.

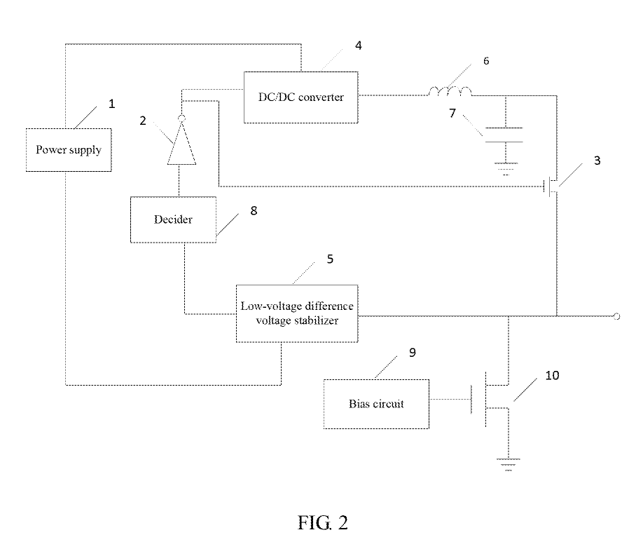

FIG. 2 is a schematic structural diagram of an apparatus for improving standby efficiency of a handheld device according to some embodiments of the present disclosure. As illustrated in FIG. 2, the apparatus includes: a power supply 1, a phase inverter 2, a field-effect transistor 3, and a direct/direct (DC/DC) converter 4 and a low-voltage difference voltage stabilizer 5 that are connected in parallel; wherein the power supply 1 provides an input voltage for the DC/DC converter 4 and the low-voltage difference voltage stabilizer 5, an input port of the phase inverter 2 is connected to an enable port of the low-voltage difference voltage stabilizer 5, the input port of the phase inverter 2 is connected to an enable port of the DC/DC converter 4, a gate of the field-effect transistor 3 is connected to an output port of the phase inverter, a drain of the field-effect transistor 2 is connected to an output port of the DC/DC converter 4, and a source of the field-effect transistor 2 is connected to an output port of the low-voltage difference voltage stabilizer 5.

In this embodiment, an enable signal may be input via the enable port of the DC/DC converter and the low-voltage difference voltage stabilizer, such that the DC/DC converter and the low-voltage difference voltage stabilizer are enabled or disabled. Specifically, when a high level is input to the enable port, the DC/DC converter or the low-voltage difference voltage stabilizer is enabled; and when a low level is input to the enable port, the DC/DC converter or the low-voltage difference voltage stabilizer is disabled.

In this embodiment, through the effect of the phase inverter, the enable signals input to the DC/DC converter and the low-voltage difference voltage stabilizer may be reverse to each other in logic. That is, if the enable signal input to the enable port of the DC/DC converter is a high level, the enable signal input to the enable port of the low-voltage difference voltage stabilizer is a low level. As such, it may be ensured that at the same moment, only one of the DC/DC converter and the low-voltage difference voltage stabilizer is enabled, and the other thereof is disabled.

For example, in this embodiment, when the handheld device is in a working state, the enable signal may be set to a low level. As such, the enable signal input to the enable port of the low-voltage difference voltage stabilizer is a low level, such that the low-voltage difference voltage stabilizer is disabled. Under the effect of the phase inverter, the enable signal input to the enable port of the DC/DC converter is a high level, and in this case a high level is also input to the gate of the field-effect transistor. In this way, the DC/DC converter and the field-effect transistor are both enabled. Under such a circumstance, the DC/DC converter may convert a first voltage provided by the power supply into a second voltage, and use an output voltage upon amplification by the field-effect transistor to supply power for the handheld device. In this case, since the handheld device is in the working state, the output voltage of the DC/DC converter is large, such that a high working efficiency may be ensured.

In this embodiment, when the handheld device is in the standby state, the enable signal may change from a low level to a high level. In this case, the low-voltage difference voltage stabilizer may be enabled, whereas the DC/DC converter and the field-effect transistor may be disabled. Under such a circumstance, the voltage supplied by the power supply for the low-voltage difference voltage stabilizer may be, for example, 1.5 V, whereas the output voltage of the low-voltage difference voltage stabilizer may reach 1.3 V. In this case, the working efficiency of the handheld device is 1.4/1.5=93.33%. Accordingly, the handheld device in the standby state may also maintain a high working efficiency.

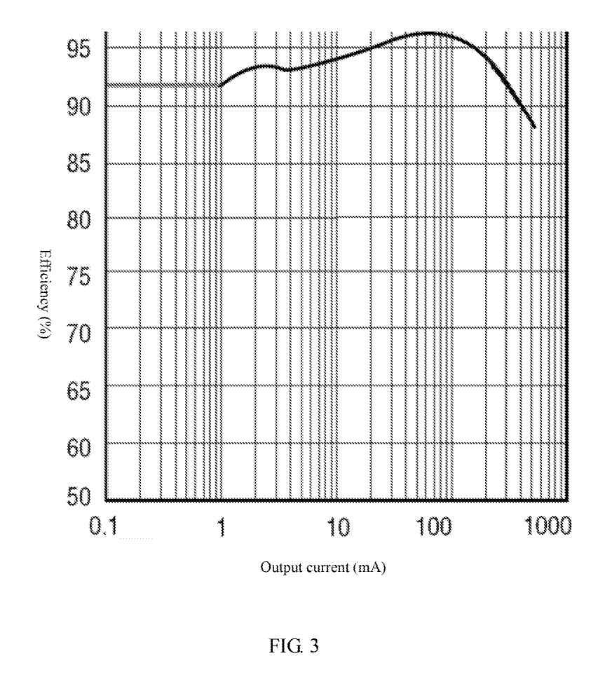

Referring to FIG. 3, FIG. 3 is a schematic diagram illustrating working efficiency of a handheld device according to some embodiments of the present disclosure. As seen from FIG. 3, the apparatus for improving standby efficiency of a handheld device according to this embodiment may enable the handheld device in the standby state to still maintain an efficiency of over 90%.

In a specific embodiment of the present disclosure, to provide a relatively stable direct current voltage for the handheld device, a filter circuit may be arranged between the output port of the DC/DC converter 4 and the drain of the field-effect transistor 3. Referring to FIG. 2, the filter circuit may include an inductor 6 and a capacitor 7 that are connected in series, wherein two terminals of the inductor 6 are respectively connected to the output port of the DC/DC converter 4 and the drain of the field-effect transistor 3, one terminal of the capacitor 7 is connected to the drain of the field-effect transistor 3, and the other terminal of the capacitor 7 is grounded. Under such a circumstance, when an alternating current voltage is doped in the output voltage of the DC/DC converter, since the alternating current voltage generates a great impedance when passing through the inductor and the alternating current voltage may be directly led to the ground via the capacitor, alternating current components in the output voltage may be filtered such that the output voltage only includes the direct current voltage, and the handheld device may be normally supplied with power.

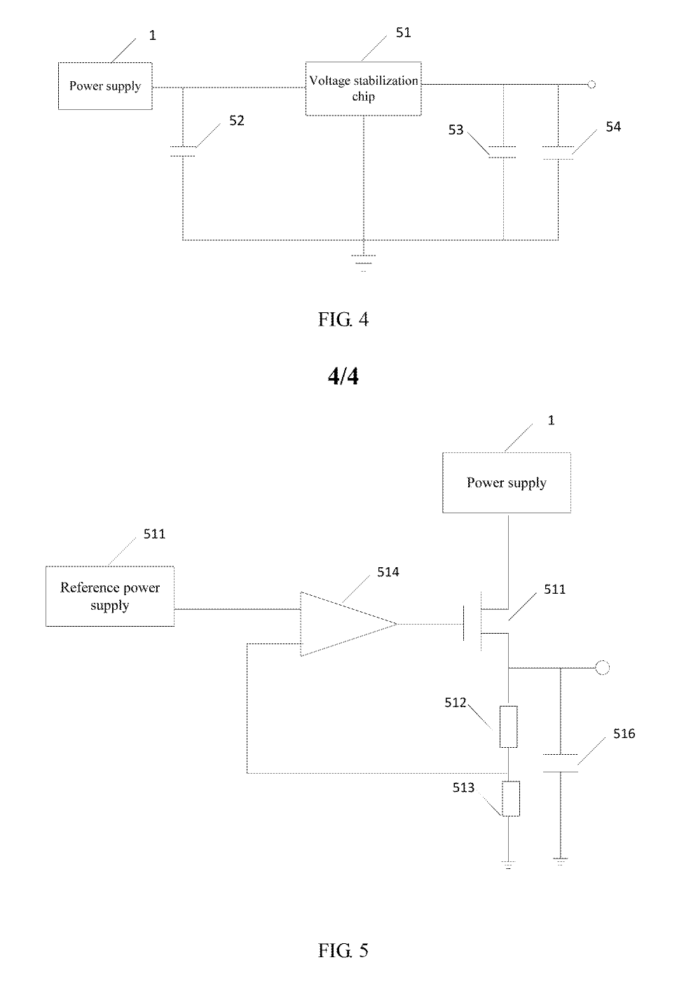

Referring to FIG. 4, in some embodiments of the present disclosure, the low-voltage difference voltage stabilizer 5 includes a voltage stabilization chip 51, a first capacitor 52, a second capacitor 53 and a third capacitor 54; wherein a first pin of the voltage stabilization chip 51 is connected to the power supply 1, a second pin of the voltage stabilization chip 51 is grounded, a third pin of the voltage stabilization chip 51 is a voltage output pin, the first pin is grounded via the first capacitor 52, and the second capacitor 53 and the third capacitor 54 are connected in parallel between the third pin and the ground.

In this embodiment, the voltage stabilizer chip 51 may be HM6206, HT7530, HT7133-1 or the like chip. Nevertheless, during specific implementation, the chip is not limited to the above several models, and any chip that is capable of implementing the function of the stabilizer chip may be used.

In this embodiment, the first capacitor 52 between the first pin of the voltage stabilization chip 51 and the ground may be configured to filter the voltage provided by the power supply 1. Likewise, the second capacitor 53 may also be configured to filter the output voltage of the stabilization chip 51.

In some embodiments of the present disclosure, since the current state of the handheld device needs to be judged, a decider 8 may be configured in the apparatus. A signal output port of the decider 8 is connected to the input port of the phase inverter 2, and the decider 8 may decide the state of the handheld device, and generate an enable signal according to a decision result. Specifically, the decider 8 may detect the usage rates of the CPU and the memory of the handheld device. When the detection result exceeds a predetermined threshold, it may be considered that the handheld device is currently in an activated state; when the detection result does not reach the predetermined threshold, it may be considered that the handheld device is currently in a standby state.

In this embodiment, when the decider 8 decides that the handheld device is in the activated state, a low-level enable signal may be output. Under such a circumstance, the DC/DC converter and the field-effect transistor may be triggered to be enabled, such that the low-voltage difference voltage stabilizer is disabled. On the contrary, when the decider 8 decides that the handheld device is in the standby state, a high-level enable signal may be output. Under such a circumstance, the low-voltage difference voltage stabilizer may be triggered to be enabled, such that the DC/DC converter and the field-effect transistor are disabled.

In some embodiments of the present disclosure, considering that the input voltage of the low-voltage difference voltage stabilizer may be subjected to fluctuations, to ensure that the low-voltage difference voltage stabilizer may dynamically adjust the value of the output voltage according to the fluctuations of the input voltage, so as to maintain the voltage difference between the output voltage and the input voltage within a predetermined range, the schematic structure of the low-voltage difference voltage stabilizer as illustrated in FIG. 5 may be employed. Referring to FIG. 5, the low-voltage difference voltage stabilizer 5 may include a reference power supply 511, a first voltage divider resistor 512, a second voltage divider resistor 513, an error amplifier 514 and a driving transistor 515; wherein a non-inverting input terminal of the error amplifier 514 is connected to the reference power supply 511, an output terminal of the error amplifier 514 is connected to a gate of the driving transistor 515, a drain of the driving transistor 515 is connected to the power supply 1, the first voltage divider resistor 512 and the second voltage divider resistor 513 that are connected in series are arranged between the source of the driving transistor 515 and the ground, and an inverting input terminal of the error amplifier 514 is connected between the first voltage divider resistor 512 and the second voltage divider resistor 513.

In this embodiment, the reference power supply 511 may be configured to generate a reference voltage, and input the reference voltage to the non-inverting input terminal of the error amplifier 514. A voltage divided from the output voltage by the first voltage divider resistor 512 and the second voltage divider resistor 513 may be input to the inverting input terminal of the error amplifier 514. In this way, a feedback circuit may be established between the input terminal and output terminal of the error amplifier 514. The output terminal of the error amplifier 514 is connected to the gate of the driving transistor 515, the first voltage divider resistor 512 and the second voltage divider resistor 513 divides the output voltage of the error amplifier 514, and feeds back a portion of the voltage to the inverting input terminal of the error amplifier 514. The driving transistor 515 stabilizes the value of the final output voltage according to a comparison result between the reference voltage and the divider voltage obtained by the error amplifier 514. In this way, when the output voltage of the low-voltage difference voltage stabilizer changes, the voltage fed back by the voltage divider resistor to the inverting input terminal may also change accordingly, such that the voltage difference between the reference voltage and the divider voltage is caused to change. The driving transistor 515 may adjust the final output voltage of the low-voltage difference voltage stabilizer in real time according to the voltage difference, so as to ensure that the output voltage of the low-voltage difference voltage stabilizer synchronously change with the change of the input voltage, such that it is ensured that the voltage difference between the output voltage and the input voltage is maintained within a predetermined range.

In this embodiment, a decoupling capacitor 516 may also be arranged between the driving transistor 515 and the ground, wherein the decoupling capacitor 516 is connected in parallel to the first voltage divider resistor 512 and the second voltage divider resistor 513 that are connected in series, and the decoupling capacitor 516 may be configured to eliminate the impacts caused by changes of load of the handheld device to the output voltage of the low-voltage difference voltage stabilizer.

In a specific embodiment of the present disclosure, considering that the state of the working circuit changes, in particular during the course that the working circuit of the digital circuit is changed from an enabled state to a disabled state, an abrupt reduction of the load current may cause the output voltage signal of the low-voltage difference voltage stabilizer to be subjected to great overshoot, although the voltage overshoot quantity may be reduced by arranging a decoupling capacitor at the output terminal of the low-voltage difference voltage stabilizer, in consideration of the cost, the decoupling capacitor is generally very small. Therefore, the effect of preventing voltage overshoot is generally poor. Based on this, in this embodiment, the apparatus may further include a bias circuit 9 and a source follower 10; wherein the bias circuit 9 is connected to a gate of the source follower 10, a source of the source follower 10 is connected to the output port of the low-voltage difference voltage stabilizer 5, and a drain of the source follower 10 is grounded.

In this embodiment, the source of the source follower 10 is connected to the output port of the low-voltage difference voltage stabilizer 5; when the load current of the low-voltage difference voltage stabilizer 5 is abruptly reduced, the voltage signal output at the output port of the low-voltage difference voltage stabilizer 5 is subjected to overshoot, and in this case the voltage at the source of the source follower 10 increases, the working current of the source follower 10 quickly increases within a short period of time, and thus a pull-down current is generated, such that the voltage overshoot quantity of the voltage signal is reduced.

As seen from the above, in the apparatus for improving standby efficiency of a handheld device according to the embodiments of the present disclosure, a low-voltage difference voltage stabilizer is connected in parallel to a DC/DC converter, and the DC/DC converter or the low-voltage difference voltage stabilizer may be selectively used to supply power for the handheld device according to the current state of the handheld device. When the handheld device is in an activated state (a communication mode), the DC/DC converter supplies power for the handheld device, and in this case, the DC/DC converter outputs a great current, and a high working efficiency may be ensured. When the handheld device is in a standby state (a standby mode), the low-voltage difference voltage stabilizer may supply power for the handheld device, and in this case, a voltage difference between the output voltage and the input voltage of the low-voltage difference voltage stabilizer is small, and a high working efficiency may be still ensured. Accordingly, the apparatus for improving standby efficiency of a handheld device according to the embodiments of the present disclosure is capable of improving the efficiency of the handheld device in the standby state.

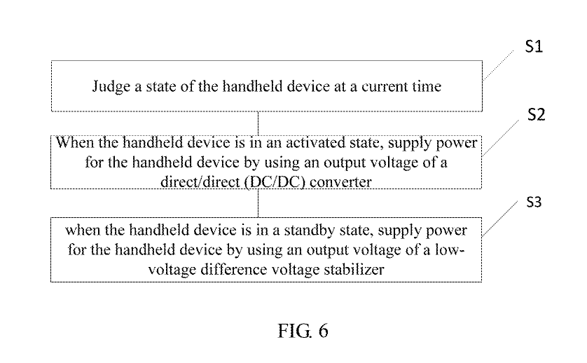

Embodiments of the present disclosure further provide a method for improving standby efficiency of a handheld device. Referring to FIG. 6, the method may include the following the following steps:

step S1: judging a state of the handheld device at a current time; and

step S2: when the handheld device is in an activated state, supplying power for the handheld device by using an output voltage of a direct/direct (DC/DC) converter; or

step S3: when the handheld device is in a standby state, supplying power for the handheld device by using an output voltage of a low-voltage difference voltage stabilizer.

In a specific embodiment of the present disclosure, prior to the supplying power for the handheld device by using an output voltage of a direct/direct (DC/DC) converter, the method may further include:

filtering the output voltage of the DC/DC converter.

In a specific embodiment of the present disclosure, prior to the supplying power for the handheld device by using an output voltage of a low-voltage difference voltage stabilizer, the method may further include:

performing overshoot protection for the output voltage of the low-voltage difference voltage stabilizer by using a bias circuit and a source follower.

It should be noted that the implementation process of the above steps S1 to S3 is consistent with the implementation process of the apparatus for improving standby efficiency of a handheld device, which is thus not described herein any further.

As seen from the above, in the method for improving standby efficiency of a handheld device according to the embodiments of the present disclosure, the low-voltage difference voltage stabilizer is connected in parallel to the DC/DC converter, and the DC/DC converter or the low-voltage difference voltage stabilizer may be selectively used to supply power for the handheld device according to the current state of the handheld device. When the handheld device is in an activated state (a communication mode), the DC/DC converter supplies power for the handheld device, and in this case, the DC/DC converter outputs a great current, and a high working efficiency may be ensured. When the handheld device is in a standby state (a standby mode), the low-voltage difference voltage stabilizer may supply power for the handheld device, and in this case, a voltage difference between the output voltage and the input voltage of the low-voltage difference voltage stabilizer is small, and a high working efficiency may be still ensured. Accordingly, the method for improving standby efficiency of a handheld device according to the embodiments of the present disclosure is capable of improving the efficiency of the handheld device in the standby state.

In this specification, such terms “first” and “second” are merely used for differentiating one element or action from another element or action, but not intended to define or imply any practical sequential relationship or sequence. Where the environment permits, reference to an element or part or step (and the like) shall not be interpreted as being limited to one of the element, part and step, but may be one or more of the element, part and step.

The above descriptions of the embodiments of the present disclosure are provided for demonstration to persons skilled in the art, instead of exhaustively listing all the embodiments or limiting the present disclosure to a single disclosed embodiment. In view of the above, various replacements and variations to the present disclosure are apparent to persons skilled in the art. Therefore, although some alternative embodiments have been discussed in detail, other embodiments are apparent or can be readily derived by a person skilled in the art. The present disclosure is intended to cover all the replacements, modifications and variations to the present disclosure that have been discussed here as well as other embodiments consistent with the spirit and scope of the present disclosure.

Various embodiments in the specification are described in a progressive manner. The same or similar parts between the embodiments may be referenced to each other. In each embodiment, the portion that is different from other embodiments is concentrated and described. In particular, with respect to a method embodiment, since it is substantially similar to the system embodiment, brief description is given. The related portions may be referenced to the description of the portions in the system embodiment.

Although the present disclosure is described with reference to the embodiments, persons of ordinary skill in the art would know that various variations and modifications may be derived without departing from the spirit of the present disclosure. It should be noted that such variations and modifications shall cover within the scope defined by the appended claims without departing from the spirit of the present disclosure.

What is claimed is:

1. An apparatus for improving standby efficiency of a handheld device, the apparatus comprising: a power supply, a phase inverter, a field-effect transistor, and a direct/direct (DC/DC) converter and a low-voltage difference voltage stabilizer that are connected in parallel; wherein the power supply provides an input voltage for the DC/DC converter and the low-voltage difference voltage stabilizer, an input port of the phase inverter is connected to an enable port of the low-voltage difference voltage stabilizer, the input port of the phase inverter is connected to an enable port of the DC/DC converter, a gate of the field-effect transistor is connected to an output port of the phase inverter, a drain of the field-effect transistor is connected to an output port of the DC/DC converter, and a source of the field-effect transistor is connected to an output port of the low-voltage difference voltage stabilizer.

2. The apparatus for improving standby efficiency of a handheld device according to claim 1, wherein a filter circuit is arranged between the output port of the DC/DC converter and the drain of the field-effect transistor, the filter circuit comprising an inductor and a capacitor that are connected in series; wherein two terminals of the inductor are respectively connected to the output port of the DC/DC converter and the drain of the field-effect transistor, one terminal of the capacitor is connected to the drain of the field-effect transistor, and the other terminal of the capacitor is grounded.

3. The apparatus for improving standby efficiency of a handheld device according to claim 1, wherein the low-voltage difference voltage stabilizer comprises a voltage stabilization chip, a first capacitor, a second capacitor and a third capacitor; wherein a first pin of the voltage stabilization chip is connected to the power supply, a second pin of the voltage stabilization chip is grounded, a third pin of the voltage stabilization chip is a voltage output pin, the first pin is grounded via the first capacitor, and the second capacitor and the third capacitor are connected in parallel between the third pin and the ground.

4. The apparatus for improving standby efficiency of a handheld device according to claim 1, the apparatus further comprising a decider; wherein a signal output port of the decider is connected to the input port of the phase inverter, and the decider decides a state of the handheld device and generates an enable signal according to a decision result.

5. The apparatus for improving standby efficiency of a handheld device according to claim 1, wherein the low-voltage difference voltage stabilizer comprises a reference power supply, a first voltage divider resistor, a second voltage divider resistor, an error amplifier and a driving transistor; wherein a non-inverting input terminal of the error amplifier is connected to the reference power supply, an output terminal of the error amplifier is connected to a gate of the driving transistor, a drain of the driving transistor is connected to the power supply, the first voltage divider resistor and the second voltage divider resistor that are connected in series are arranged between the source of the driving transistor and the ground, and an inverting input terminal of the error amplifier is connected between the first voltage divider resistor and the second voltage divider resistor.

6. The apparatus for improving standby efficiency of a handheld device according to claim 5, wherein a decoupling capacitor is further arranged between the source of the driving transistor and the ground, the decoupling capacitor is connected in parallel to the first voltage divider resistor and the second voltage divider resistor that are connected in series.

7. The apparatus for improving standby efficiency of a handheld device according to claim 1, the apparatus further comprising a bias circuit and a source follower; wherein the bias circuit is connected to a gate of the source follower, a source of the source follower is connected to the output port of the low-voltage difference voltage stabilizer, and a drain of the source follower is grounded.

8. A method for improving standby efficiency of a handheld device, applied to a terminal, the method comprising:
judging a state of the handheld device at a current time, and
when the handheld device is in an activated state, supplying power for the handheld device by using an output voltage of a direct/direct (DC/DC) converter; or
when the handheld device is in a standby state, supplying power for the handheld device by using an output voltage of a low-voltage difference voltage stabilizer.

9. The method for improving standby efficiency of a handheld device according to claim 8, wherein prior to the supplying power for the handheld device by using an output voltage of a direct/direct (DC/DC) converter, the method further comprises:
filtering the output voltage of the DC/DC converter.

10. The method for improving standby efficiency of a handheld device according to claim 8, wherein prior to the supplying power for the handheld device by using an output voltage of a low-voltage difference voltage stabilizer, the method further comprises:
performing overshoot protection for the output voltage of the low-voltage difference voltage stabilizer by using a bias circuit and a source follower.
